(19) United States
(12) Patent Application Publication
(10) Pub. No.: US 2017/0315906 A1
(43) Pub. Date: Nov. 2, 2017

(54) METHOD FOR ALLOCATING MEMORY SPACE

(71) Applicant: Safran Identity & Security, ISSY-LES-MOULINEAUX (FR)

(72) Inventor: Pascal François Paul DUMAS, ISSY LES MOULINEAUX (FR)

(21) Appl. No.: 15/497,835

(22) Filed: Apr. 26, 2017

(30) Foreign Application Priority Data
Apr. 27, 2016 (FR) 1653719

(51) Int. Cl. G06F 12/02

(52) U.S. Cl. CPC G06F 12/023; G06F 2212/1044

(57) ABSTRACT

The present invention concerns a method for allocating a space of predetermined size in a memory (2) of a smart card (1), characterized in that it comprises steps of: deterministic preselection (100) in the memory (2), of at least one free zone having a size larger than the predetermined size, selection, (104) in a preselected free zone of a sub-zone having a size equal to the predetermined size, the selection of the sub-zone being variable for one same preselected free zone, use (106) of the selected sub-zone as allocated memory space.

### FIELD OF THE INVENTION

The present invention concerns a method for allocating space in a memory of a smart card.

### STATE OF THE ART

Conventionally, the writing of data in a memory is preceded by allocating space in the memory, this space being used to host data. On the basis of an input size to be allocated, an allocation algorithm looks for and selects a region in the memory having at least this size and marked as free in the memory (i.e. not already allocated). Typically, the allocation algorithm returns an address of the selected region.

An allocation algorithm is generally deterministic: for a determined memory configuration and for a determined size to be allocated, the region selected in the memory by the algorithm is always the same.

In this respect, allocation algorithms are known that follow different and even competing objectives. For example, some deterministic algorithms look for and select a region in the memory minimising the execution time of the allocation algorithm but likely to fragment the memory. Other, slower, deterministic algorithms look for and select a region in the memory which minimises memory fragmentation.

Some memories are more particularly intended to store confidential data. This is the case with smart cards. On this account, it is important to protect the confidentiality and integrity of the memory content of such secure elements against different types of attack: deterioration, observation, perturbation.

One known method to attack a smart card is to find the exact location of sensitive data in the memory and to modify this location directly or to perturb the reading or writing thereof, or to observe the utilisation thereof to infer the value therefrom.

Regarding low-cost, mass produced smart cards for which a deterministic allocation method is used, an attack via localisation of sensitive data in the memory of a given sample of this model can be replicated at will for any other sample of the same model, without requiring any additional effort.

To protect a secure element memory against such attack by data localisation, it has been proposed to use a random memory space allocation method (ASLR or Address Space Layout Randomization). In this manner, the allocated region is not always the same, for a determined space size and for a determined memory configuration, which means that a particular datum may be located at different places in the memory with two different executions (e.g. on two different samples of the same secure element model).

However, the implementation of said method may cancel the advantages related to deterministic allocation: said method may therefore prove to be slower and/or may lead to more memory fragmentation than with deterministic allocation.

### DESCRIPTION OF THE INVENTION

It is therefore one objective of the invention to protect a memory of a smart card efficiently against attacks of “data localisation” type, whilst preserving the advantages of a deterministic allocation method.

In a first aspect of the invention there is therefore proposed a method for allocating a space of predetermined size in a memory of a smart card, comprising steps of:
deterministic preselection, in the memory, of at least one free zone having a size larger than the predetermined size;
selection, in a preselected free zone, of a sub-zone having a size equal to the predetermined size, the selection of the sub-zone being variable for one same preselected free zone;
use of the selected sub-zone as allocated memory space.

The preselection step of the free zone follows a deterministic policy; therefore, implementation thereof allows benefit to be drawn from the advantages provided by this deterministic policy.

Unlike the free zone, which can be fully determined from the requested predetermined size and from the current configuration of the memory, a sub-zone is variably selected. In other words, for a determined preselected zone, and for a determined memory configuration, two different executions of the sub-zone selection step may give different results i.e. select two different sub-zones inside the free zone. Therefore, with the proposed method it is possible efficiently to protect said memory against attacks of “data localisation” type.

The proposed allocation method ultimately allows preserving of the advantages of the deterministic allocation policy applied at the preselection step, whilst adding possible diversification thereto (by means of the variable selection step of the sub-zone).

The allocation method has further advantages:
at no time does it require the allocation of additional space in relation to the normal memory allocation mechanism;
it is applicable to all types of memories (volatile and non-volatile);
it is applicable to allocations for the memorising of data and program codes (e.g. Java code);
if necessary, it allows replication at will of memory mapping;
it only requires few resources;
it can be rapidly executed.

When the deterministic preselection step uses a policy of “first-fit” type, the allocation method then offers a good trade-off between rapidity of execution and protection against attacks of “data localisation” type.

When the deterministic preselection step uses a policy of “next-fit” type, the allocation method is then more rapid than with the “first-fit” policy, but requires the maintaining in memory of information on the last allocation performed.

When the deterministic preselection step uses a policy of “best-fit” type, the allocation method then offers a good compromise between minimised fragmentation of the memory and protection against attacks of “data localisation” type.

The sub-zone can be selected from among several candidate sub-zones included in the preselected free zone:
a first candidate sub-zone having a start address equal to the start address of the selected free zone and/or;
a second candidate sub-zone having an end address equal to the end address of the selected free zone and/or;
a third candidate sub-zone having a start address strictly higher than the start address of the selected free zone, and an end address strictly lower than the end address of the selected free zone.

If the candidate sub-zones are solely formed of the above-mentioned first sub-zone and second sub-zone, the allocation method applied strongly minimises memory fragmentation.

If the candidate sub-zones comprise the first sub-zone, second sub-zone and at least one third zone as mentioned above, the allocation method allows more diversified memory mapping to be obtained.

The sub-zone can be selected randomly in the selected free zone so that the result of allocation will be fully unpredictable, thereby making unpredictable the space where data will be written in the memory.

Alternatively, the sub-zone can be selected pseudo-randomly in the selected free zone, which will assist a programr in debugging the code that executes the allocation method, whilst making the result of allocation practically unpredictable.

The selected free zone may be contiguous and/or the sub-zone may be contiguous, which simplifies implementation of the allocation method.

In a second aspect of the invention there is proposed a computer program product comprising program code instructions to execute the steps of the allocation method according to the first aspect of the invention when this program is executed by at least one processor.

In a third aspect of the invention, a smart card is proposed comprising at least one memory and at least one processor configured to execute the computer program product according to the second aspect of the invention for the purpose of allocating space in the memory.

### DESCRIPTION DES FIGURES

Other characteristics, objectives and advantages of the invention will become apparent from the following description that is non-limiting and solely illustrative, and is to be read in connection with the appended drawings in which:

FIG. 1 schematically illustrates a secure element according to one embodiment of the invention.

FIG. 2 is a flow chart of steps of a memory space allocation method according to one embodiment of the invention.

FIGS. 3, 4 and 5 schematically illustrate the content of a memory in three different statuses.

In all the Figures, similar elements carry the same references.

### DETAILED DESCRIPTION OF THE INVENTION

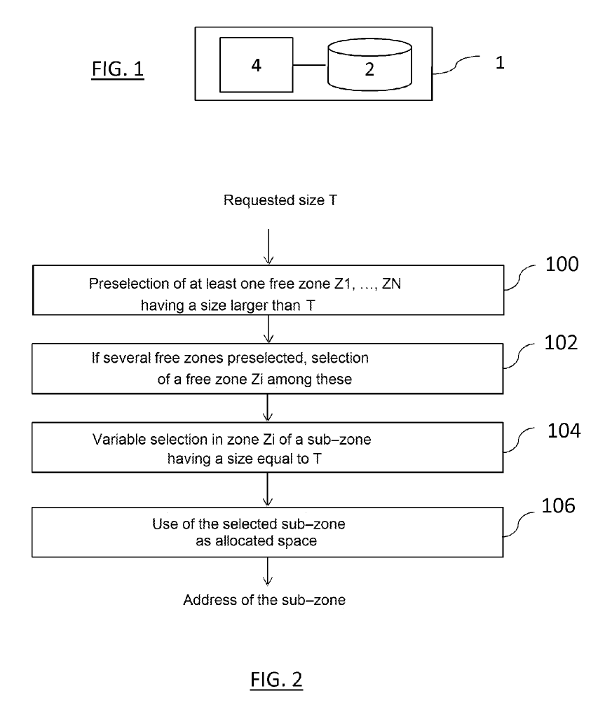

With reference to FIG. 1, a secure element 1 comprises at least one memory 2 and at least one processor 3.

The secure element 1 is a smart card for example.

The memory 2 is of EEPROM, FLASH, hard disk, SSD type or any other type of memory capable of memorising data, confidential data in particular.

For example, the memory 2 is intended to memorise cryptographic keys.

The processor 3 is configured to execute program code instructions of a program managing the memory 2 of the secure element 1. This management program 2 implements an allocation method the functioning of which is detailed below.

The program 4 is also configured to execute the code instructions of other programs e.g. user programs which call the management program to obtain read and/or write access to the memory 2.

The program managing the memory 2 is memorised for example in the memory itself 2 or in another memory dedicated to this purpose.

In the remainder hereof, it is considered that the memory 2 has a certain bit size and that this memory is divided into memory units, each memory unit having “free” status or “allocated” status. Each memory unit has its own address in the memory.

In the present document, it is considered that a memory zone 2 is defined by at least one start address, at least one end address and a size in number of memory units. In particular, when the zone under consideration is a contiguous zone, this zone can be defined by a single start address and single end address. It is also possible to define a contiguous zone by a start address and a size, the end address then being equal to the start address plus the size.

It is also assumed in the following that the end address of a first contiguous zone is equal to the start address of a second contiguous zone which follows immediately after the first zone in the memory 2.

With reference to FIG. 2, a method for allocating space in the memory 2 comprises the following steps.

A user program calls an allocation function or method implemented in the management program. A size T to be allocated (in number of memory units for example) is entered as a parameter of this function or method.

At step 100, the management program selects in the memory 2 at least one free zone of memory 2 having a size strictly larger than the requested size T and which is free (i.e. formed of memory units each having “free” status).

This preselection is conducted using a deterministic policy.

The preselection step 100 is conducted using a “first-fit” deterministic policy for example. In this case, the management program scans the memory in a predetermined direction (e.g. in increasing address or decreasing address order). The management program preselects the first free zone found in the memory having a size equal to or larger than the requested size. The execution of this “first-fit” policy is particularly rapid.

As a variant, preselection 100 is conducted following a “next-fit” policy. In this case, rather than scanning the entirety of the memory to determine a sufficiently large free zone starting from one end of the memory as in the “first-fit” policy, the management program scans the memory in a predetermined direction starting at the address of the last allocation made by the management program. Therefore, the rapidity of execution of preselection is even faster than with the “first-fit” policy, provided however that information on the last allocation made is memorised (e.g. the start address of the last allocated zone).

In another variant, preselection 100 is conducted following the “best-fit” policy, known to persons skilled in the art. In this case, the zone preselected after step 100 is a zone having a size larger than but the closest to size T, which allows minimised fragmentation of the memory 2 induced by the allocation in progress.

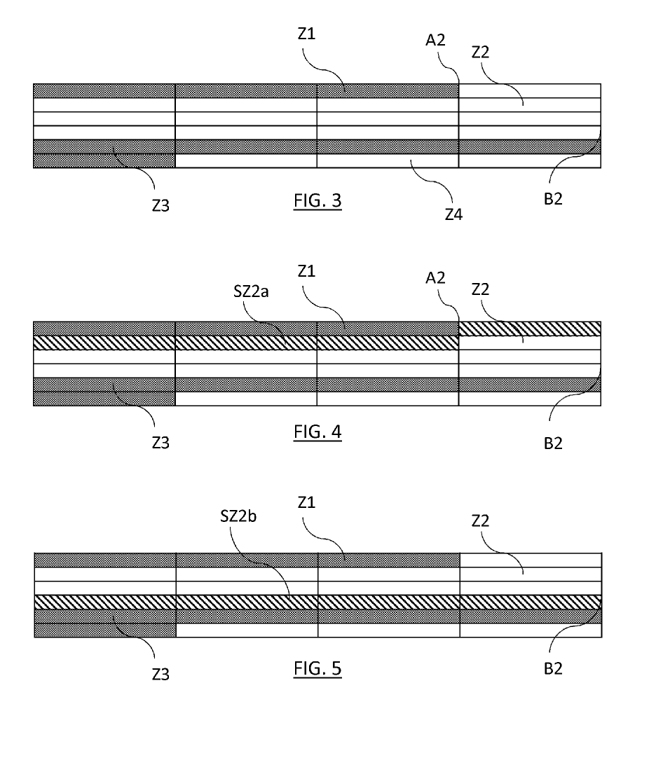

FIG. 3 schematically illustrates a memory 2 comprising 20 memory units, each unit being represented by a rectangle. The memory units having “free” status are represented in white, and the grey memory units have “allocated” status. By convention, the unit in the top left of FIG. 4 has the memory start address (e.g. “zero” address), and the memory unit 2 in the bottom right of FIG. 4 has the end address of the memory 2. For example, a memory unit is an octet.

Therefore, the memory 2 illustrated in FIG. 4 comprises the following successive zones, from its start address to its end address:
an allocated zone Z1 of size 3 (counted in number of memory units);
a free zone Z2 of size 13;
an allocated zone Z3 of size 5; and
a free zone Z4 of size 3.

For example, if T=4, the only zone that can be preselected at step 100 is zone Z2 since it is the only free zone having a size larger than 4.

Nonetheless, in other configurations of the memory 2, it may happen that several zones are able simultaneously to meet the criterion set by the deterministic policy used at preselection step 100. For example, if a “best-fit” policy is used at preselection step 100, several zones minimising memory fragmentation into identical proportions can be preselected 100 (e.g. several identified free zones of same size).

If several zones are thus preselected 100, one of these preselected zones is selected at step 102.

The selection 102 can be performed randomly or pseudo-randomly.

At step 104, the management program selects a sub-zone located inside the free zone selected at step 102 (or singly preselected at step 100).

The selected sub-zone is of the same size as the requested size T.

Unlike step 100, which follows a deterministic policy, the sub-zone selected at step 104 is variable. In other words, for a determined preselected zone, and for a determined configuration of the memory 2, two different executions of step 104 by the management program can give different results i.e. select two different sub-zones of the free zone.

In one embodiment, the selection 104 of the sub-zone is random. For this purpose, a random number generator (RNG) is used by the management program. In this case, it is fully impossible to predict the sub-zone that will be selected by the management program at a subsequent execution of step 104, which largely improves the protection of the secure element against attacks targeting the location of sensitive data. Said random selection 104 can be based for example on non-predictable physical phenomena such as an electric current circulating in the secure element 1.

In another embodiment, the selection 104 of the sub-zone is pseudo-random. For this purpose, a pseudo-random number generator is used by the management program (PRNG). In this case, it is possible to predict the next selection to be made by the management program, provided the parameters of the pseudo-random generator used are known (in general, at least one of these parameters is a seed). Said pseudo-random selection 104 is particularly advantageous for debugging purposes by a programr implementing the management program, whilst providing a reasonable degree of security for the secure element 1; the above-mentioned prediction remains very difficult without knowledge of the parameters of the pseudo-random generator used.

The sub-zone is selected from among several candidate sub-zones included in the preselected free zone (and of size T).

If step 104 is configured to seek a sub-zone that is a contiguous sub-zone, in a free zone that itself is contiguous, the candidate sub-zones differ solely through different start addresses; these sub-zones are simply offset from one another in the preselected free zone.

A first candidate sub-zone has a start address equal to the start address of the selected free zone. FIG. 4 illustrates said choice: the selected free zone Z2 of size 13 has A2 has start address; at step 104 the sub-zone SZ2a of size T having A2 as start address can be selected (the selected sub-zone therefore has A2+T as end address).

A second candidate sub-zone has an end address equal to the end address of the selected free zone. FIG. 5 illustrates said choice: the selected free zone Z2 of size 13 has B2=A2+13 as end address; at step 104 the sub-zone SZ2b of size T having B2 as end address can be selected (the selected sub-zone therefore has B2-T as start address).

Other candidate sub-zones can also be envisaged, each of these other candidate sub-zones having a start address strictly higher than the start address of the selected free zone, and an end address strictly lower than the end address of the selected free zone. In the configuration illustrated in FIG. 4, and for T=4, there are 8 candidate sub-zones meeting these conditions.

In one embodiment, the candidate sub-zones have start addresses offset from one another by only one octet in the preselected zone. Each sub-zone included in the preselected zone and having a start address of form A2+k, where k is an integer equal to or higher than zero, is a candidate zone. In the configuration illustrated in FIG. 4, and for T=4, there are 10 candidate sub-zones: the first sub-zone SZ2a, second sub-zone SZ2b, and the 8 other sub-zones discussed in the preceding paragraph.

In another embodiment, the candidate sub-zones are formed of the above-mentioned first sub-zone (at the start of the free zone) and of the second sub-zone (at the end of the free zone). This allows major limiting of fragmentation of the memory 2. Each of the two sub-zones that can be selected 104 are contiguous to already allocated zones (Z1 and Z3 in the example illustrated in FIGS. 3 to 5). In this embodiment with two candidate selections, the mapping of the memory 2 then varies by a power of 2 of the number of allocated zones. In a smart card, several tens, even several hundred different zones are commonly allocated for the memorising of separate data, which introduces corresponding variability in the mapping of one sample of a secure element model to another.

At step 106, the program uses the sub-zone selected at step 104 as allocated space.

This use 106, for example, comprises marking of the memory units forming the selected sub-zone in “allocated” status. Evidently, the other memory units contained in the free zone selected at step 100 remain in “free” status, and hence available for a subsequent allocation request. In the case illustrated in FIGS. 4 and 5, with T=4, the free zone Z2 has a size of 13 and therefore after step 106 there remain 9 free memory units located between the allocated zones Z2 and Z3.

Use 106 further comprises the providing of an address of the allocated sub-zone (e.g. its start address) to the program which requested allocation of a space of size T.

When the allocation method is implemented in a program function or method using size T as parameter, this address may be a result returned by this function or method.

At this stage, data can be written in the allocated sub-zone.

If the “next-fit” policy is followed at preselection step 100, the management program also memorises information on the allocated sub-zone (typically its start address). In response to a subsequent allocation request, the management program will scan the memory 2 in a predetermined direction starting with this memorised address.

The freeing of a previously allocated zone by means of the method of the invention is implemented in conventional manner. After such freeing, the memory units forming the freed zone are configured in “free” status.

The method for allocating memory space is evidently not limited to the embodiment just described with reference to the Figures. In particular, the example was taken in the foregoing that the zones examined by the memory management program are contiguous. The method of the invention can particularly be generalised so that the respective results of preselection step 100 and/or selection step 102 and/or selection step 104 give memory zones which are not necessarily contiguous but formed of several contiguous blocks.

1. A method for allocating a space of predetermined size in a memory of a smart card, wherein it comprises steps of:
preselecting in the memory at least one free zone having a size larger than the predetermined size using a deterministic policy;
selecting in the preselected free zone a sub-zone having a size equal to the predetermined size, wherein selecting the sub-zone is variable for one same preselected free zone;
use of the selected sub-zone as allocated memory space.

2. The method according to claim 1, wherein the sub-zone is selected from among several candidate sub-zones included in the preselected free zone, wherein a first candidate sub-zone thereof has a start address equal to the start address of the selected free zone.

3. The method according to claim 1, wherein the sub-zone is selected from among several candidate sub-zones included in the preselected free zone, wherein a second candidate sub-zone thereof has an end address equal to the end address of the selected free zone.

4. The method according to claim 1, wherein the sub-zone is selected from among several candidate sub-zones included in the preselected free zone, wherein a third candidate sub-zone thereof has a start address strictly higher than the start address of the selected free zone, and has an end address strictly lower than the end address of the selected free zone.

5. The method according to claim 1, wherein the sub-zone is selected from a group of candidate sub-zones having start addresses offset from one another by only one octet in the preselected zone.

6. The method according to claim 2, wherein the sub-zone is selected from among several candidate sub-zones included in the preselected free zone, wherein a second candidate sub-zone thereof has an end address equal to the start address of the selected free zone, wherein the candidate sub-zones consist of the first sub-zone and second sub-zone only.

7. The method according to claim 1, wherein the sub-zone is selected randomly in the selected free zone.

9. The method according to claim 1, wherein the selected free zone is contiguous and/or wherein the reserved sub-zone is contiguous.

10. The method according to claim 1, wherein the deterministic policy is of “best-fit” type.

11. The method according to claim 1, wherein the deterministic policy is of “next fit” type.

12. The method according to claim 1, wherein the deterministic policy is of “first-fit” type.

13. The method according to claim 1 wherein, if the several free zones are preselected, then selecting the sub-zone is conducted in a free zone selected randomly or pseudo-randomly from among the preselected free zones.

14. A computer program product comprising program code instructions to execute the steps of the allocation method according to claim 1, when this program is executed by at least one processor.

15. A smart card comprising:
at least one memory,
at least one processor configured to execute the computer program product according to claim 14, for the purpose of allocating space in the memory.
